(19) United States
(12) Patent Application Publication
(10) Pub. No.: US 2015/0113853 A1
(43) Pub. Date: Apr. 30, 2015

(54) FISH STRIKE DETECTION METHODS AND APPARATUS

(71) Applicant: Echelon Solutions Group, LLC, Glenview, IL (US)

(72) Inventors: Michael McKeough, Glenview, IL (US); Dean Demertzis, Glenview, IL (US); Paurav Patel, St. Charles, IL (US)

(21) Appl. No.: 14/521,964

(22) Filed: Oct. 23, 2014

Related U.S. Application Data
(60) Provisional application No. 61/895,209, filed on Oct. 24, 2013.

(51) Int. Cl. A01K 93/02; G01L 1/00; G01P 15/00; A01K 97/12

(52) U.S. Cl. CPC A01K 93/02; A01K 97/125; G01L 1/00; G01P 15/00
USPC 43/17; 702/41

(57) ABSTRACT

Systems and methods for detecting fishing conditions are disclosed. An example system includes a housing having a first portion connected to a second portion to create a watertight seal. The example housing encloses, for example, sensors configured to measure force applied to the housing and a processor to determine acceleration based on an output from the sensor, and to determine if the sensor output indicates a fish strike. Other sensors (such as sensors to measure water clarity, temperature, acidity, and the like) can also be included within the housing. The example housing also includes a transceiver communicatively coupled to the processor configured to wirelessly transmit an indication of the fish strike or other water conditions based on data received from the sensor(s). In an embodiment, the system provides for data aggregation, enabling anglers to ascertain fishing conditions based on data from a plurality of sensors over a wide geographic area.

### PRIORITY CLAIM

This application is a non-provisional application of, and claims priority to and the benefit of U.S. Provisional Patent Application No. 61/895,209, filed Oct. 24, 2013, the entire contents of which is incorporated herein by reference.

### BACKGROUND

Setting a hook is arguably one of the most important skills in fishing. However, knowing precisely when to set the hook and the amount of force needed to set the hook usually requires years of fishing experience. Setting a hook too quickly can cause the loss of a biting fish. At the same time, setting a hook too slowly (or with insufficient force) can also cause the loss of a biting fish (or alternatively a gut-hooked fish).

Additionally, factors such as fish species, timing, and bait presentations often require appropriate adjustments for setting a hook. For instance, hooks should be set fast and with great force for aggressive fish that are hitting the bait hard. In contrast, hooks should be set relatively slower and with less force for neutral or passive fish that are nibbling at bait. Moreover, hooks should be set quickly for some species of fish (e.g., pike) and relatively slowly for other species (e.g., trout).

To set a hook, any slack in the fishing line is removed to increase bite sensitivity and increase the force of a hookset. Removing the slack includes reeling in excess fishing line and/or pointing the fishing rod toward the biting fish. Responsive to sensing a fish strike for an appropriate duration, the fishing rod is pulled or snapped upward. This upward (or sideward) action ideally causes the hook to penetrate the mouth of the fish. After the hook has been initially set, the fishing line is reeled in to maintain steady pressure on the fish to keep the hook set or further drive the hook into the mouth to complete the set.

Oftentimes, anglers become excited at the first instance of a fish bite (especially if they have been waiting for a substantial amount of time or are inexperienced) and set the hook too quickly. In other instances, anglers become distracted and miss an opportunity to set a hook. In yet other instances, ice fishers miss bites while they are warming in their shanties.

In addition to knowing when to set a hook, another aspect of fishing successfully and enjoyably is to select an appropriate location. For example, anglers frequently want to fish in areas where fish populations are high. This can be affected by several factors, including pollution, food availability, water temperature, dissolved oxygen, salinity, turbidity, and/or total dissolved solids. However, it is currently difficult or impossible for anglers to accurately discern the pertinent factors of potential fishing locations in real-time.

### SUMMARY

The present disclosure provides a new and innovative system, method, and apparatus for detecting fish strikes. In an example embodiment, a fishing bobber is configured to include a sensor to measure forces applied by biting fish to a fishing line attached to the fishing bobber. The sensor is arranged within the fishing bobber so as to measure, for example, downward acceleration of the fishing bobber corresponding to a fish bite/strike. The fishing bobber also includes a processor configured to determine a force based on an output from the sensor, determine if the force corresponds to a fish strike, and wirelessly transmit an indication of the fish strike (e.g., transmit the indication via the Bluetooth® wireless protocol). Alternatively, the fishing bobber may wirelessly transmit any force measured by the sensor.

The example embodiment also includes a client device (e.g., a smartphone) that includes a wireless receiver configured to receive the force data from the fishing bobber. The client device further includes a processor configured to output an indication of a fish strike based on the force data. The processor may operate an application (e.g., an app) that is programmed to output a visual, vibrational, and/or audio indication of a fish strike. The application also provides an indication as to when the hook should be set. The indication is based on the detected force in conjunction to any data provided by a user (e.g., target fish species, estimated fish behavior, etc.). The application may also enable a user to publish information regarding the fish strike/catch (and corresponding geographic location) to third-party social media applications and/or to a fish strike server configured to aggregate and make available fish strike/catch data from a plurality of users.

In this embodiment or alternative embodiments, the application on the client device may enable a user to specify a threshold for providing an indication of a fish strike/bite. The application may also enable a second threshold to be set to indicate when a hook should be set based on measured force. The thresholds may be numerical force values. Alternatively, the application may determine the threshold(s) based on user specified information including, for example, target fish species, time of day, expected mood of fish, etc. The application uses the specified or calculated threshold to determine when to provide an indication to a user of the fish strike/bite and/or when to set a hook. Alternatively, the application may program the processor within the bobber to only output force data that is above the specified threshold or provide indications of a bite/strike/hook set.

In various embodiments, the fishing bobber can additionally include one or more sensors to measure water quality including, for example, water temperature, dissolved oxygen, salinity, turbidity, and/or total dissolved solids. The processor in the fishing bobber is configured to wirelessly transmit the water quality data to the client device, which accordingly displays the water quality data. In some embodiments, the client device may also transmit the water quality data to a third-party website and/or to a fish strike server in conjunction with the strike/bite/catch data.

In embodiments where data can be transmitted to servers and/or third-party websites, the disclosed system enables the aggregation of data about fishing conditions in various locations. In one such embodiment, the disclosed system uses a GPS device within a smartphone to provide information about the location of data sensed by the sensor(s) within a fishing bobber. In this embodiment, the smartphone uploads both the location information and the information sensed by the sensor(s) to a remote server, such as a third-party web server. The remote server then provides other users with the capability to view aggregated data collected by the sensor(s) based on geographic location. In various embodiments, this enables users to make informed decisions about where fish are likely to strike based on actual strikes, water quality and temperature, and the like.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of an example fish strike detection environment.

FIGS. 2 and 3 show diagrams of different types of fishing bobbers.

FIG. 4 shows an example functional diagram of the fishing bobbers of FIGS. 1 to 3, according to an example embodiment of the present disclosure.

FIGS. 5 and 6 shows example data structures of data provided by the fishing bobbers of FIGS. 1 to 4, according to an example embodiment of the present disclosure.

FIG. 7 shows a data structure of multiple thresholds that may be programmed into the fishing bobbers of FIGS. 1 to 4 and/or an application operating on a client device of FIG. 1.

FIGS. 8 and 9 show a flow diagram including example procedures to provision and receive data from a fishing bobber, according to an example embodiment of the present disclosure.

FIGS. 10 to 14 show example user interfaces displayable by the client device of FIG. 1 to configure and display data provided by the fishing bobbers of FIGS. 1 to 4.

### DETAILED DESCRIPTION

In one embodiment, the system disclosed herein enables the detection of fish strikes. In one particular embodiment, the disclosed system relies on a bobber-based sensor to wirelessly transmit measured force data to a client device to indicate a fish strike. As discussed herein, a fish strike/bite corresponds to an action performed by a fish on a fishing hook. A fish generally performs a strike/bite to acquire bait on a fishing hook. In regards to magnitude of force, a bite generally corresponds to relatively less force associated with a fish tasting or nibbling at bait while a strike generally corresponds to relatively more force associated with a fish grabbing or latching on to the bait (and hook).

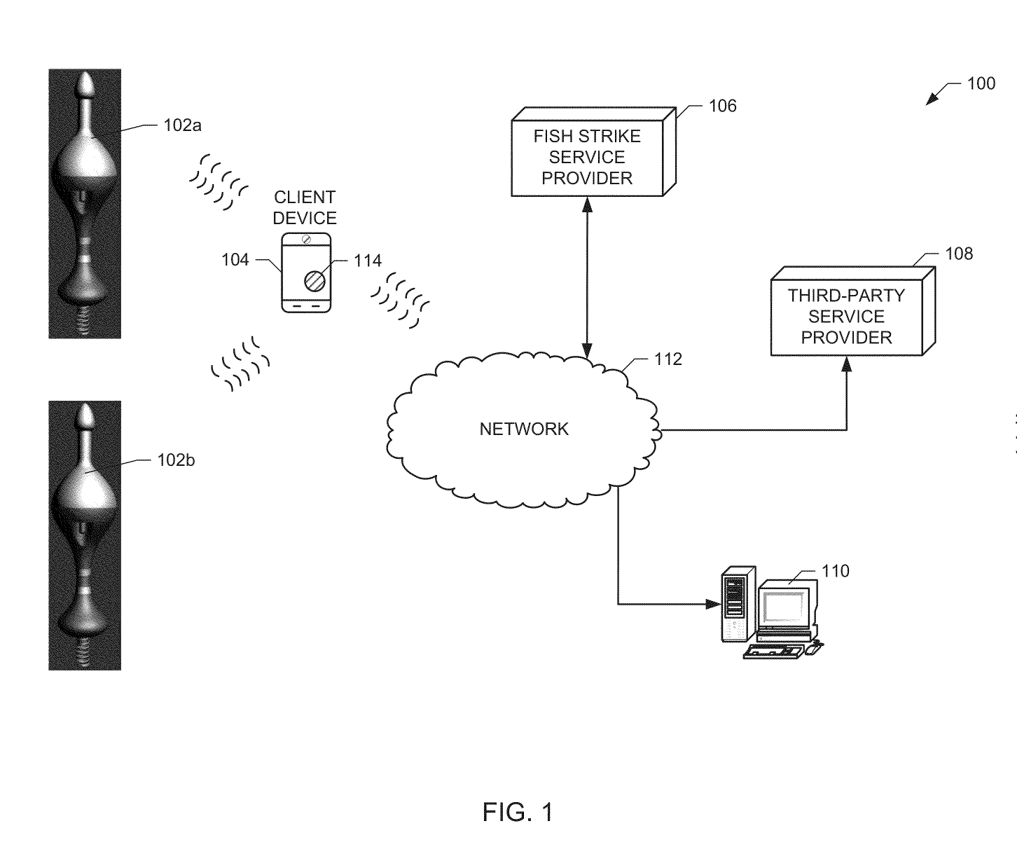

FIG. 1 shows a diagram of an example fish strike detection environment 100, which includes fishing bobbers 102a and 102b and a client device 104. The environment 100 also may include a fish strike service provider 106, a third-party service provider 108, and/or a client processor 110. The client device 104 is communicatively coupled to the providers 106 and 108 and/or the client processor 110 via any wired and/or wireless connection (e.g., the Internet) 112.

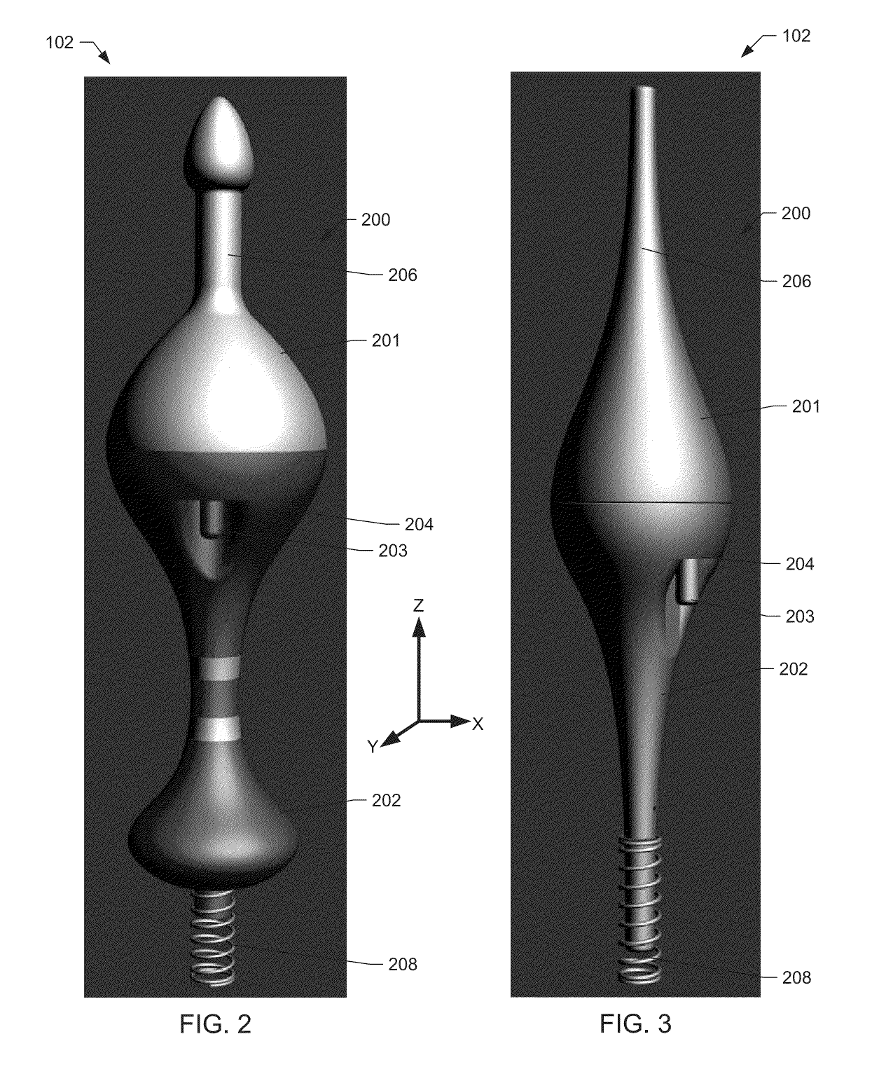

As discussed herein, the fishing bobbers 102a and 102b of the illustrated embodiment each enclose a sensor, processor and transceiver for detecting and transmitting force data indicative of a fish bite/strike. The fishing bobbers 102a and 102b may be configured to be any shape and/or may be configured to be disposed in any depth of water (e.g., surface, 1 foot below water surface, etc.). The fishing bobbers 102a and 102b are connected to fishing line, which is also connected to a fishing hook. While the disclosure refers to fishing bobbers, sensors and corresponding components may be included within fishing lures, floats, and/or any other device that is connectable to fishing line. The fishing bobbers 102a and 102b are described in further detail in conjunction with FIGS. 2 to 4.

The example client device 104 includes any type of smartphone, laptop, tablet computer, processor, computer, server, personal digital assistant, smartwatch, smart belt clip, digital eyewear, or any other device that may receive wireless force data and provide a corresponding output indicative of the data. The indication of force data may be displayed graphically in the form of an icon/picture (e.g., a green circle to indicate a fish strike/bit), numerical data (e.g., force readout), an animation (e.g., animation of a fish strike), etc. The indication may also include an audio sound (e.g., beep, music, ringtone, and voice), a vibration, and/or an activation of a light emitting diode (“LED”). In some instances, the indication may be provided in proportion to the force. In particular, the client device 104 may vibrate or provide an audio indication at an intensity in proportion to the force.

The client device 104 of FIG. 1 includes a fish strike application 114 that processes force data (and/or water quality data) received from the fishing bobbers 102a and 102b. The fish strike application 114 may transmit the force data in conjunction with other data to the service providers 106 and 108 and/or the client processor 110. The other data can include, for example, water quality data, day/time data, geo-location as determined by the client device 104 (or provided by the user), weather (including solar and/or lunar information) as determined by the client device 104 or third-party weather site (or provided by the user), etc. Collectively, the force data and other data are referred to herein as fish strike data.

The fish strike application 114 may be installed on the client device 104 responsive to a user using the client device 104 to access an application store. From the store, the client device 104 requests to download the application 114. The client device 104 may then install the application 114. In other embodiments, the client device 104 may use a web browser to access a website hosted by, for example, the fish strike service provider 106. From the website, the client device 104 may request to download and install the application. In yet other embodiments, the application 114 may be cloud-based being located, for example, at the fish strike service provider 106. In these other embodiments, the client device 104 uses the network 112 to access the application 114 hosted by the service provider 106.

It should be appreciated that the application 114 may be some combination of local program on the client device 104 that interacts with a cloud-based component at the service provider 106. In these instances, the application 114 at the client device 104 functions as an interface for functionality and/or data resident at the service provider 106. For instance, the application 114 at the client device 104 may display or provide an indication of a fish strike while the cloud-based portion of the application 114 stores data associated with the fish strike (e.g., force amount, time of day, geographic location, water quality, weather, user identifier, etc.).

The service providers 106 and 108 include any type of processor, server, computer, or any other device for hosting a service. The service providers 106 may be cloud-based and/or include functionality at one or few servers. The fish strike service provider 106 may host a service for accumulating and/or aggregating fish strike data from multiple client devices 104 and making this data available to other users. The aggregated data may be displayed, for example, within an electronic map or chart and indicate a time/date, water quality, weather, fish species, etc. associated with the fish strike. The fish strike service provider 106 may also operate promotions and/or contests based in part on the fish strike data received from users.

The third-party service provider 108 includes any social media, file sharing, content provider, etc. that enables users to store and/or share data. The client device 104 accesses the third-party service providers 108 via the network to provide data associated with a fish strike. For instance, a user may post to their Facebook® profile their fish strike data in conjunction with a photo/video of the caught fish. This enables the user's social media contacts in various embodiments to see not only the result of a fishing expedition (i.e., a picture of the catch), but also information about the conditions in which the fish was caught.

The client processor 110 may include any laptop, computer, processor, server, tablet computer designed to store fish strike data from the client device 104. For instance, the client processor 110 may be located at a residence of a user. The client device 104 streams and/or periodically transmits the fish strike data to the client processor 110, which stores the data. In one embodiment, a user uses the client processor 110 to analyze fish strike data including, for example, correlating fish strikes to geographic locations, time/day, fish species, weather, water quality, etc. It should be appreciated that the client device 104 may also perform analysis and correlation functions.

The fishing bobbers 102a and 102b are configured to wirelessly transmit force data (and/or water quality data) to the client device 104. The force data may be transmitted periodically, streamed, and/or transmitted for forces exceeding a specified threshold. The force data in one embodiment includes a magnitude of force corresponding to a fish strike. The force data can additionally or alternatively include an indication of a strike. For instance, the fishing bobbers 102a and 102b may only send an indication of a fish strike responsive to detecting the strike. The fishing bobbers 102a and 102b may also be configured to transmit water quality data, as will be discussed in more detail below. This data may be streamed and/or transmitted periodically.

The wireless transmission between the fishing bobbers 102a and 102b and the client device 104 may be using a Bluetooth® wireless communication protocol, a Zigbee® wireless communication protocol, Near Field Communication (“NFC”), an IEEE 802.11 wireless protocol, a cellular protocol (e.g., 2G PCS, 2G GSM, 2G CDMA, PDC, iDEN, TDMA), etc. In some instances, the fishing bobbers 102a and 102b are mated or otherwise communicatively coupled to the client device 104 prior to use. This mating enables a user configure the client device 104 to output fish strike indications from multiple fishing bobbers simultaneously deployed in the water. The mating also ensures that the client device 104 does not provide indications of strikes from other non-linked fishing bobbers or other users. The client device 104 is configured to enable any one of the linked fishing bobbers 102a and 102 to be delinked when not in use.

In some embodiments, the client device 104 may be initially linked to the fishing bobbers 102a and 102b. The client device 104 may periodically check whether the fishing bobbers 102a and 102b are active and provide a corresponding indication as to which bobber is active. The check may be performed upon detecting a power-up/activation of the fishing bobbers 102a and/or 102b and/or by transmitting a status request message. In other embodiments, the fishing bobbers 102a and 102b may become active responsive to detecting a force corresponding to a cast or contact with water. In these embodiments, the fishing bobbers 102a and 102b are configured to begin transmitting force data and/or strike detection indications to the client device 104 after becoming active.

FIGS. 2 and 3 show diagrams of different types of fishing bobbers 102. In particular, FIG. 2 shows a diagram of the fishing bobber 102 in a lighthouse shape and FIG. 3 shows a diagram of the fishing bobber 102 in a swordfish shape. It should be appreciated that the bobbers 102 can include additional shapes as desired and/or as needed to accommodate varying types of sensors or other electronics.

The example fishing bobbers 102 may be enclosed to have a solid particle protection to prevent dust from affecting interior processors, sensors, transceivers, etc. The example fishing bobbers 102 may also be enclosed to have a water protection up to one meter. Alternatively, the fishing bobbers 102 may provide water protection for deeper depths. The fishing bobbers 102 may be constructed of plastic, rubber, etc. to withstand mechanical damage from a fall of at least four feet.

The fishing bobbers 102 include a housing 200 (or enclosure) including a first portion 201 and a second portion 202. The first and second portions are connected together to form a water and/or dust tight seal. A user may disconnect the first portion 201 from the second portion 202 to access components within the housing 200 (e.g., to replace a battery). The housing 200 is configured to enclose internal components such as sensors, circuit boards, processors, batteries, transceivers, antennas, etc. The shape and/or dimensions of the housing 200 may be based on the size/layout of enclosed components and/or bouncy considerations.

The fishing bobbers 102 also include a power button 203 included with the second portion of the housing 202. A user depresses the power button 203 to provide power to internal components. In alternative embodiments, the power button 203 may instead include a sliding switch. In one embodiment, no power button is provided; instead, communication via a radio frequency transmitter may provide operating power to a switch contained within the bobber.

A power indicator 204 (e.g., a LED) may be located in proximity to the power button 203 to indicate that the fishing bobber 102 is powered. Alternatively, the power indicator 204 may be located atop a stem portion 206 of the first portion 201 of the housing 200. Multiple power indicators 204 connected to a common light output may be used such that a different colored light is output based on a condition of the fishing bobber 102. For instance, a green light could be output when a battery has sufficient change, a red light could be output when the battery requires changing/replacement, a yellow light could be output when the fishing bobber 102 is unpaired, and a blue light could be output upon pairing the fishing bobber 102 with a client device 104.

The example stem portion 206 of the housing 200 may also include at least a portion of an antenna. For instance, an antenna may be included internally within the stem portion 206. Additionally or alternatively, the exterior of the stem portion 206 may be comprised of metal to function as an antenna. It should be appreciated that the positioning of an antenna in the stem portion 206 improves the range of wireless communication with the client device 104.

The example fishing bobbers 102 of FIGS. 2 and 3 also include a connector 208 configured to connect to fishing line. A user ties or otherwise places/secures fishing line into the connector 208 to secure the fishing bobber 102 prior to use. While the connector 208 is shown as a spring, in other embodiments the connector 208 may include a latch, a hook, etc.

In some embodiments, the antenna may be integrated with the connector 208 and/or couple to a portion of the fishing line through the connector 208. For instance, an antenna may extend from a base of the housing 200 through the connector 208 and warp around or otherwise connect to a portion of fishing line. Such a configuration enables data to be transmitted from a submerged bobber 102 because at least a portion of the antenna would be wrapped around fishing line that is above water. Alternatively, the fishing line may be conductive and function as a part of the antenna by being connected to the connector 208.

The example housing 200 of the fishing bobbers 102 may also be integrated with one or more water quality sensors. For instance, the housing 200 may include a window or sensor element that enables a water quality sensor to directly measure water properties. The water quality sensors may be configured to measure, for example, water temperature, dissolved oxygen, salinity, turbidity, total dissolved solids, and/or pH.

The example housing 200 of the fishing bobbers 102 may also be integrated with a micro USB port and/or other electronic port. The port may enable the client device 104 and/or the client processor 110 to connect to the electronic components of the fishing bobber 102. Such a connection may facilitate changing a power supply, programming a processor with a force threshold, downloading force data from a processor, etc. The port may include a cover that prevents water and/or dust from entering the housing 200 during use.

### Fishing Bobber Functional Embodiment

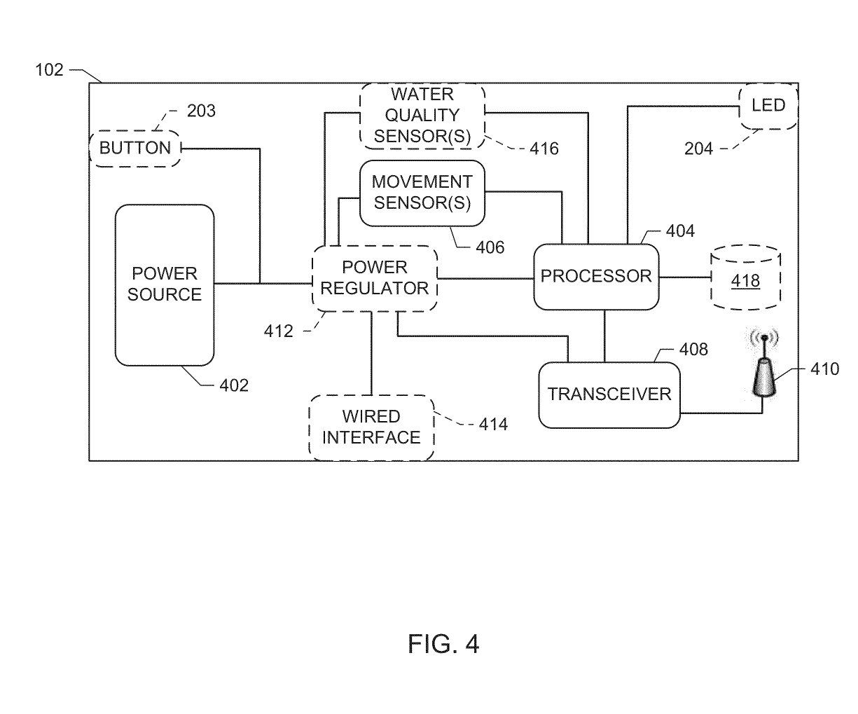

FIG. 4 shows an example functional diagram that could be used with the fishing bobbers 102 illustrated in FIGS. 1 to 3, according to an example embodiment of the present disclosure. The example fishing bobber 102 includes a power source 402, a processor 404, a movement sensor 406, a transceiver 408, and an antenna 410. The example fishing bobber 102 may also include a power regulator 412 a wired interface 414, one or more water quality sensors 416, a memory 418, a power indicator 204, and a button 203.

### Power

In the illustrated example, the power source 402 is configured to provide power to other components of the fishing bobber 102 including the processor, 404, the sensors 406 and 416, the power indicator 204, and/or the transceiver 408. The power source 402 may include a battery such as a coin cell battery and/or a lithium polymer battery. The power source 402 may also include one or more power monitoring circuits configured to determine a remaining change. Alternatively, the processor 404 and/or the power regulator 412 monitors the power source 402 for remaining charge.

In some instances, the power source 402 may be rechargeable. For example, a user may provide recharging power for the power source 402 through the wired interface 414. Alternatively, the power source 402 may include a radio frequency receiver that is configured to receive power wirelessly from a corresponding charging station. For example, the power source 402 may be charged by placing the fishing bobber 102 in proximity to a charging pad. In yet a further embodiment, the power source 402 may include a transducer configured to convert motion into power. In this instance, the power source 402 may be charged, for example, by the fishing bobber 102 being cast into water and/or by the wave motion of water.

The example power regulator 412 is configured to convert voltage from the power source 402 into a voltage compatible with the processor 404, sensors 406 and 416, transceiver 408, etc. The power regulator 412 is also configured to prevent overheating of the fishing bobber 102 or excess current draw if a short circuit occurs. The power regulator 412 is further configured to manage the charging of the power source 402 in instances when recharging power is provided via the wired interface 414 and/or via a wireless RF interface. It should be appreciated that the power regulator 412 may be omitted when the power source 402 is configured to provide a voltage that does not need to be regulated prior to being provided to the other components.

In the illustrated example embodiment of fishing bobber 102 in FIGS. 2 to 4, bobbers 102 include button 203 and power indicator 204. As discussed, the button 203 is configured to activate or provide power to the processor 404 and other components of the fishing bobber 102 responsive to a user actuating the button 203. A user depresses the button to deactivate or cut power to the processor 404 and other components of the fishing bobber 102.

The power indicator 204 of the illustrated embodiment is configured to provide a light indicative of the power state of the fishing bobber 102. As discussed, the power indicator 204 may include one or more lights (e.g., LEDs) each configured to illuminate or otherwise provide light of a specific color or hue. For instance, the power indicator 204 may provide a light indicating the fishing bobber 102 is activated. The power indicator 204 may also provide a light indicating the power source 402 has relatively low power remaining. The power indicator 204 may also indicate that a pairing with a client device 104 is in progress and/or has been completed.

The example power indicator 204 may be controlled by the processor 404. In one such embodiment, the processor 404 determines when to illuminate the power indicator 204. For example, the processor 404 may determine a charge state of the power source 402 and cause the appropriate light within the power indicator 204 to illuminate. In other instances, the power indicator 204 may be located in series with the button 203 so that a light is illuminated any time the button 203 is pressed.

### Sensors

The example movement sensor(s) 406 is configured to sense motion of the fishing bobber 102. In an embodiment, the movement sensor 406 includes an accelerometer positioned to sense acceleration of the fishing bobber 102 in the Z-direction (e.g., the water depth direction), as shown in FIGS. 2 and 3. In this manner, the movement sensor 406 is configured to sense when a fish pulls a hook, and therefore the bobber 102, during a strike. The movement sensor 406 may also be configured to sense a cast and/or when the bobber 102 contacts water. In other embodiments, the movement sensor 406 is configured to sense acceleration in the Z/X-direction or the Z/Y-direction so as to detect movement in a lateral direction in conjunction with a depth direction. Alternatively, the fishing bobber 102 includes separate movement sensors 406 or a single movement sensor for the X, Y, and Z-directions. For instance, the movement sensor 406 could include the ADXL343 3-axis digital MEMS accelerometer produced by Analog Devices®.

In other embodiments, the movement sensor 406 may include one or more inertial sensors configured to sense angular acceleration. In these other embodiments, the movement sensor 406 may include a combination of inertial sensors and accelerometers to provide linear as well as angular movement data regarding the fishing bobber 102. Alternatively, the fishing bobber 102 may only include inertial sensors.

The example movement sensors 406 are configured to output analog and/or digital signals corresponding to detected force. In some embodiments, the movement sensors 406 may be calibrated to output signals corresponding to forces within a specified range. For example, the sensors 406 may refrain from outputting signals for relatively high forces associated with casting and relatively low forces associated with water ripple/waves.

The example fishing bobber 102 of FIG. 4 may also include one or more water quality sensors 416. As discussed, the water quality sensors 416 are configured to measure water properties including, for example, water temperature, dissolved oxygen, salinity, turbidity, total dissolved solids, and pH. To measure water properties, the water quality sensors 416 may be integrated with the housing 200 of the fishing bobber 102 such that respective sensor elements contact and/or otherwise analyze water.

The water quality sensors 416 in various embodiments are configured to output digital and/or analog data representative of water property values. For example, a water temperature sensor 416 is configured to output data indicative of water temperature and a dissolved oxygen sensor 416 is configured to output data indicative of oxygen content in the water. The sensors 416 may be configured to output data continuously and/or at periodic intervals. In some instances, a water quality sensor 416 may be configured to detect the presence of water contacting a bobber 102. Responsive to detecting water, the sensor 416 may cause the processor 404 and/or transceiver 408 to switch to active or operational states.

The water quality sensors 416 may also include sonar, a camera, a thermal sensor, pressure sensor, and/or microphone. For example, a sensor 416 may be configured to transmit/receive sonar signals. In this example, the processor 404 and/or an application 114 operating on the client device 104 may use the received sonar data to determine water depth and/or profiles of detected fish/objects. It should be appreciated that a thermal sensor may also be used to detect heat transmitted by fish as a way to estimate fish size.

In another example, the sensor 416 may include a camera that is configured to record video/images. In this other example, the processor 404 is configured to process the video/images for transmission to the client device 104. An application 114 operating on the client device 104 is configured to display the recorded video/images. This configuration enables a user to view fish/conditions/objects within proximity to the bobber 102, especially in clearer water. Additionally or alternatively, the sensor 416 may include a microphone to record audio in proximity to the bobber 102. In some instances, the microphone may be provided in conjunction with the camera. In these examples, the processor 404 may include functionality for image/audio processing. Alternatively, the recorded images/audio are transmitted from the sensor 416 through the processor 404 to the client device 104 without substantial processing/filtering. In these alternative embodiments, the application 114 includes functionality to process and render the data for graphical display or audio playback.

In yet another example the sensor 416 can include a pressure sensor configured to measure water pressure. In this example, the processor 404 is configured to use data from the pressure sensor (as well as any other water quality data such as salinity) to determine a depth of the bobber 102 in instances where the bobber may be a lure or configured to float below the surface of water. The pressure sensor may be integrated with the housing 200 and/or include a detection area separate from the housing 200 configured to contact the water.

### Processor

The example fishing bobber 102 of FIG. 4 includes the processor 404 to provide data processing and transmission. In some instances, the processor 404 may be integrated with the transceiver 408 and/or the antenna 410. For example, the processor 404, transceiver 408, and/or antenna 410 may be implemented by the CC2540 Bluetooth® Low Energy System-on-Chip by Texas Instruments®. In other embodiments, the processor 404, transceiver 408, and/or the antenna 410 are separate components.

The example processor 404 is configured to perform at least the following functions: (i) pair with a client device 104, (ii) process data from sensors 406 and 416, (iii) analyze the data from the movement sensor 406 to identify a fish strike, (iv) determine data to be transmitted, and (v) manage data storage/retrieval.

Regarding pairing, the processor 404 is configured to pair with a client device 104 using, for example, the Bluetooth® Low Energy Protocol. In an example, the processor 404 determines after activation whether a pairing has been established. This determination may be made by accessing memory 418 to determine whether an identifier from a paired client device 104 is already stored. If an identifier is already stored, the processor 404 attempts to wirelessly connect with the client device 104. If a connection is established, the processor 404 begins sending data to the client device 104. If a connection is not established, the processor 404 begins a routine to establish a new pairing. This routine is also performed if the memory 418 does not include an identifier of a client device.

To pair, the processor 404 may broadcast credentials and/or an identifier and wait for a response from a client device 104. Responsive to receiving a request, the processor 404 executes a handshake process whereby an identifier of the client device 104 is stored to the memory 418. Alternatively, the processor 404 may wait for credentials and/or an identifier in a connection request message broadcast from a client device 104. Responsive to receiving the message, the processor 404 stores the identifier and transmits a response message. The response message may include, for example an identifier of the fishing bobber 102. The client device 104 stores this identifier and completes a pairing with the processor 404. After pairing is complete, the processor 404 begins transmitting data to the client device 104.

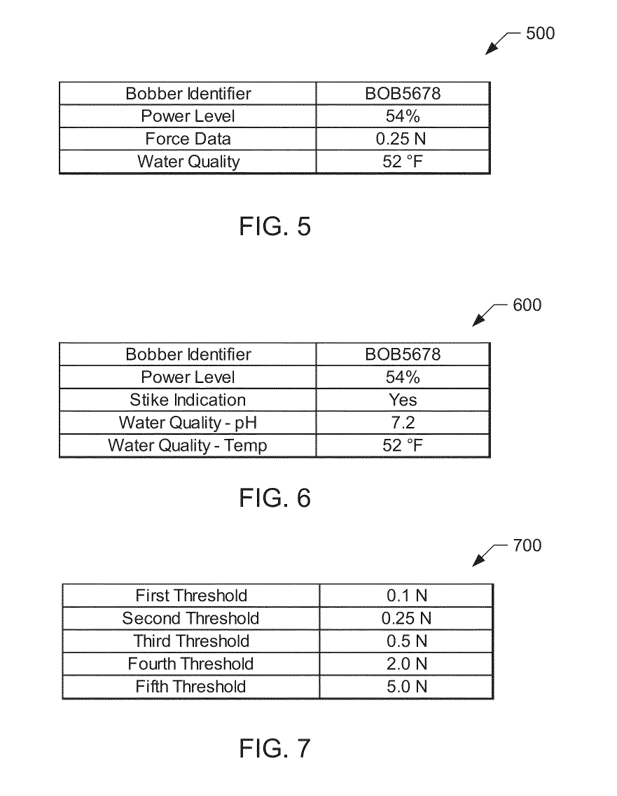

The data transmitted to the client device 104 includes, for example, force data, water quality data, and/or power data. FIGS. 5 and 6 show diagrams of example data structures 500 and 600 of data that may be transmitted by the processor 404. It should be appreciated that the processor 404 may not necessarily transmit all of the data in the data structures 500 and 600 at the same time. For instance, force data may be transmitted responsive to detecting a force above a threshold, power data may be transmitted every 5 minutes, and water quality data may be transmitted every 10 minutes. In any instances of data transmission, the processor 404 includes the bobber identifier within a header of the message. The bobber identifier enables the client device 104 to determine from which bobber 102 the data was transmitted.

In some embodiments, the processor 404 is configured to analyze and/or convert data received from the sensors 406 and 416. For instance, the processor 404 may be configured to convert digitized data from the movement sensor 406 into a corresponding force value. The force is determined, for example, by multiplying acceleration measured by the movement sensor 406 by a predefined mass of the fishing bobber 102. The processor 404 may then determine whether the force data should be transmitted.

In some embodiments, the processor 404 is configured to transmit substantially all force data (as shown in FIG. 5). In this manner, the client device 104 provides a user with a real-time or near real-time indication of force being applied to the fishing bobber 102. In alternative embodiments, the processor 404 is configured to transmit force data above one or more predetermined thresholds. In this manner, the client device 104 only receives force data that correspond to fish bites and/or fish strikes. In further embodiments, the processor is configured to transmit an indication of a fish strike and/or fish bite (as shown in FIG. 6). In this manner, the client device only receives an indication if a fish strike and/or bite and not necessarily the actual force data.

The processor 404 may also be configured to estimate the fish species and/or weight based on force data related to a strike/bite. For instance, the processor 404 may be in communication with a memory or database that stores force profiles representative of different fish species. Responsive to determining that a bite and/or strike substantially matches a profile, the processor transmits a message to the client device 104 including the determined fish species. Alternatively, the client device 104 may determine the fish species based on received force data (in conjunction with factors such as fish species associated with the local body of water from which the bobber 102 is transmitting data).

It should be appreciated that the different possible configurations for the processor 404 affect power consumption. For instance, transmission of a steady steam of force data consumes more power than periodic transmissions of force data or indications of fish strikes. In some embodiments, the processor 404 may be programmable as to the type of output desired by the user (e.g., all force data, force data above a threshold, an indication of a fish strike).

In embodiments where the processor 404 is configured to compare force data to a threshold, the processor 404 may be programmed with a standard threshold and/or be provided a threshold from the client device 104. The standard threshold may correspond to a fish strike force. The threshold provided by the client device 104 may include a specific force value specified by the user and/or may include a calculated threshold based on conditions provided by the user. For instance, a user may provide to the client device 104 a target fish species, a time/day, an estimated behavior of the fish, solar/lunar information, weather, etc. In addition, the client device 104 may use water quality data from the fish bobber 102. The client device 104 uses this information to calculate one or more thresholds appropriate for the conditions.

In an example, a user may specify that they are targeting trout during midday. The client device 104 includes a data structure that references fish species and time to corresponding predetermined fish strike thresholds. The client device 104 then performs a weighted average or other calculation to combine the different thresholds into one threshold value. After the calculation is performed, the client device 104 provides the processor 404 with the threshold.

It should be appreciated that the processor 404 may be programmed with more than one threshold. FIG. 7 shows a data structure 700 of multiple thresholds programmed into the processor 404. For example, a first threshold corresponds to a relatively low force associated with a fish bite or nibble and a second threshold corresponds to a greater force associated with a fish strike. The processor 404 accordingly outputs an indication of a fish bite when force data exceeds the first threshold and an indication of a fish strike when force data exceeds the second threshold.

The processor 404 may also be programmed with a third threshold corresponding to when a hook should be set. For instance, when force data exceeds the third threshold, the processor 404 sends an indication that the hook is to be set. The processor 404 may further be programmed to filter and/or disregard relatively high and/or low forces (forces lower than the first threshold and greater than the fifth threshold) in instances where the movement sensor 406 does not include such a filter feature. For example, the processor 404 may not transmit relatively low force data that corresponds to water ripple/waves and/or relatively high force data corresponding to casting or dropping the bobber 102.

In some embodiments, the processor 404 is configured to output indications of casting and/or reeling. For instance, the processor 404 may be programmed with a fourth threshold and/or force profile that corresponds to cast action. Responsive to receiving data from the movement sensor 406 that exceeds a cast threshold (and/or substantially matches a casting profile), the processor 404 transmits an indication of a cast. The indication can include a value of the determined force associated with the cast, a determined distance of the cast, etc. In this embodiment, the movement sensor 406 may include a piezoelectrical element (or other electrical transducer) configured to transduce bobber 102 movement into electricity to wake the processor 404 and/or the detection element of the movement sensor 406 when the bobber 102 is cast. In other words, the piezoelectrical element wakes the electrical components of the bobber 102 responsive to sensing the bobber is being used.

Similarly, the processor 404 may be programmed with a threshold and/or force profile that corresponds to a reel action. Responsive to receiving data from the movement sensor 406 that exceeds a reel threshold (and/or substantially matches a reel profile), the processor 404 transmits an indication that the bobber 102 is being reeled in toward a user. The indication can include a value of the determined force associated with the reeling, a speed of the reeling, a distance the bobber 102 has been reeled, a total time of the reeling, etc.

As mentioned, the processor 404 may include one or more force profiles corresponding to a fish strike, cast, reel, etc. A force profile may include a graph and/or a data structure with graphical values of force in relation to time. For instance, a fish strike force profile may include a first time period where the force is relatively low, a second time period where the force increases at a specified rate, and a third time period where the force exceeds a threshold, and a fourth time period where the force decreases at a specified rate. The processor 404 may include more than one profile based on conditions, estimated fish behavior, fish species, time of day/year, etc. Alternatively, the processor 404 may adjust a default force profile based on information provided by the client device 104 when the bobber 102 is linked and/or provisioned. The example processor 404 is configured to record force during a time period and compare the recorded force to one or more profiles to determine a match. Responsive to detecting a match, the processor 404 provides the appropriate indication (e.g., a fish strike, bite, cast, etc.).

As discussed, the processor 404 is configured to transmit force data, indications of fish strikes/bites, water quality data, and/or power data. To transmit this data to a client device 104, the processor 404 converts the data into one or more messages for transmission via a wireless protocol. The processor 404 then transmits the converted data to the transceiver 408, which converts the data for transmission via radio waves.

The example transceiver 408 (or a transmitter) may operate in conjunction with the processor 404 to provide a beacon signal. The beacon signal may include a bobber identifier and/or information indicative of an owner of the bobber 102. The beacon signal may be used by the client device 104 to locate a lost bobber 102 and/or inform a user who found a lost bobber of an identity of the owner. For example, the client device 104 may include an application 114 that includes a feature that instructs the device to listen for beacon signals. The application 114 may then provide a list of detected beacon signals including embedded identifiers. The application 114 may also display a heading, direction, and/or distance to each of the detected bobbers 102 based on the beacon signals. The application 114 on the client device 104 may also access an online database managed by the service provider 106 to retrieve contact information of an owner associated with the detected identifier. In this manner, a person that locates a lost bobber 102 may return it to its owner.

The example transceiver 408 (or a GPS receiver) may also operate in conjunction with the processor 404 to provide geo-location information. For example, the transceiver 408 may receive GPS satellite signals. In this example, the processor 404 is configured to decode the GPS satellite signals and determine coordinates. The processor 404 transmits the coordinates to the client device 104, which may display the location of the bobber 102 relative to a user on a map and/or provide a distance/heading to the bobber 102. It should be appreciated that the client device 104 determines the distance/heading based in part, on knowing its own coordinates or geographical location using GPS satellite signals.

In addition to transmitting data to the client device 104, the processor 404 is configured to store at least some of the data to the memory 418. The data may be stored so that the processor 404 may transmit, for example, force data and/or water quality data to a client device 104 after use in the water when data transmission conditions are better. In some instances, the processor 404 time-stamps the stored data to facilitate correlations between force data, water quality, etc. The memory 404 may be implemented by any conventional computer-readable medium, including RAM, ROM, flash memory, magnetic or optical disks, optical memory, or other storage media.

In some embodiments, the processor 404 may provide access to the stored data 418 to an external device coupled to the wired interface 414. For instance, the client processor 110 may be attached to the wired interface 414 via a mini-USB cable. Responsive to detecting the connection, the processor 404 enables data stored in the memory 418 to be downloaded to the client processor 110.

### Flowchart of the Example Process

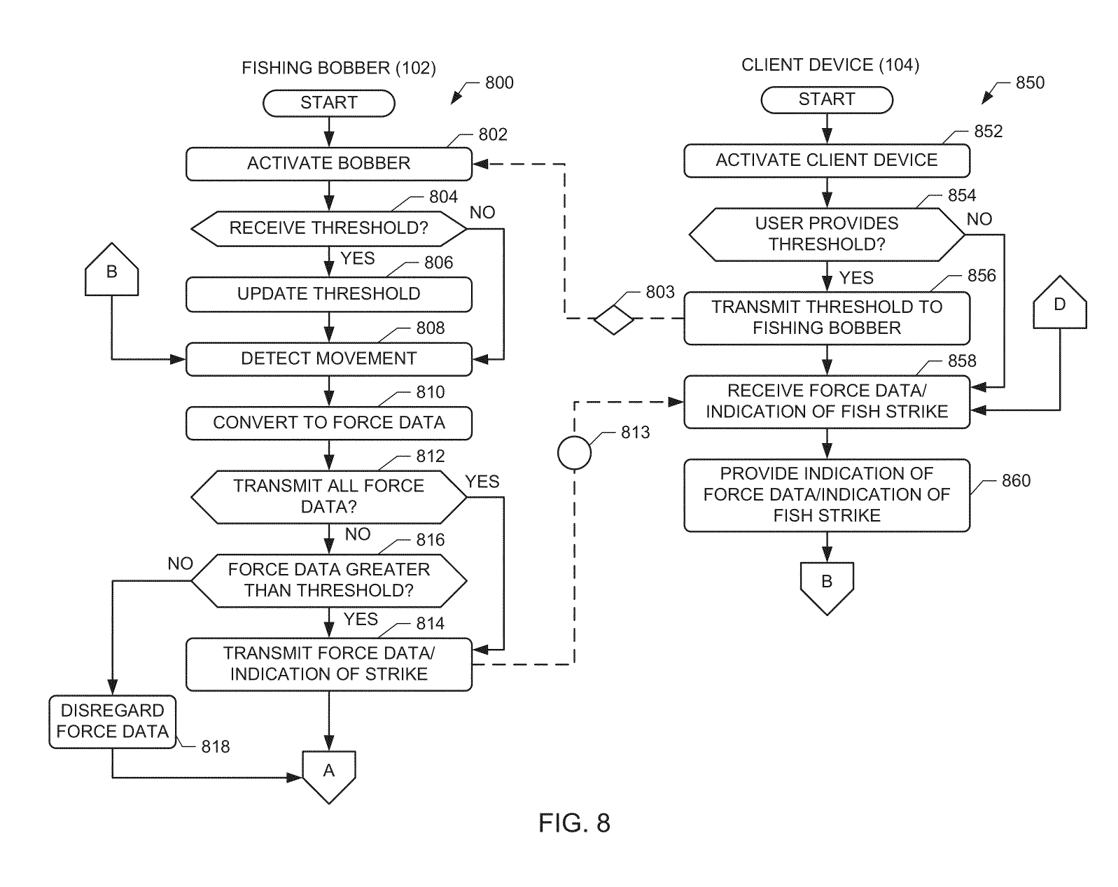

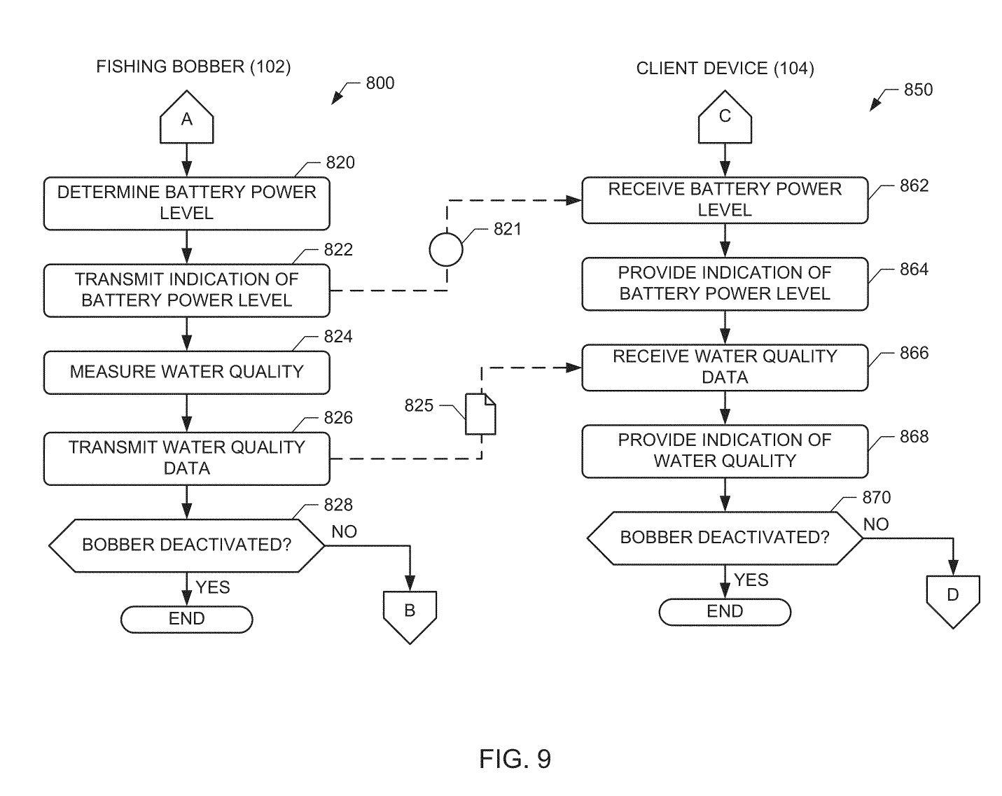

FIGS. 8 and 9 show a flow diagram including example procedures 800 and 850 to provision and receive data from a fishing bobber 102, according to an example embodiment of the present disclosure. Although the procedures 800 and 850 are described with reference to the flow diagram illustrated in FIGS. 8 and 9, it will be appreciated that many other methods of performing the acts associated with the procedures 800 and 850 may be used. For example, the order of many of the blocks may be changed, certain blocks may be combined with other blocks, and many of the blocks described are optional.

The example procedure 800 operates on, for example, the fishing bobber 102 of FIGS. 1 to 4. The procedure 800 begins when the fishing bobber 102 is powered (block 802). As discussed, the fishing bobber 102 may become powered by a user actuating button 203, detecting forces associated with a cast, and/or detecting the presence of water. It should be appreciated that in this example the fishing bobber 102 has already been linked, married, or otherwise associated with a client device 104. However, in other embodiments, the fishing bobber 102 may go through a marrying process with the client device 102 upon being activated.

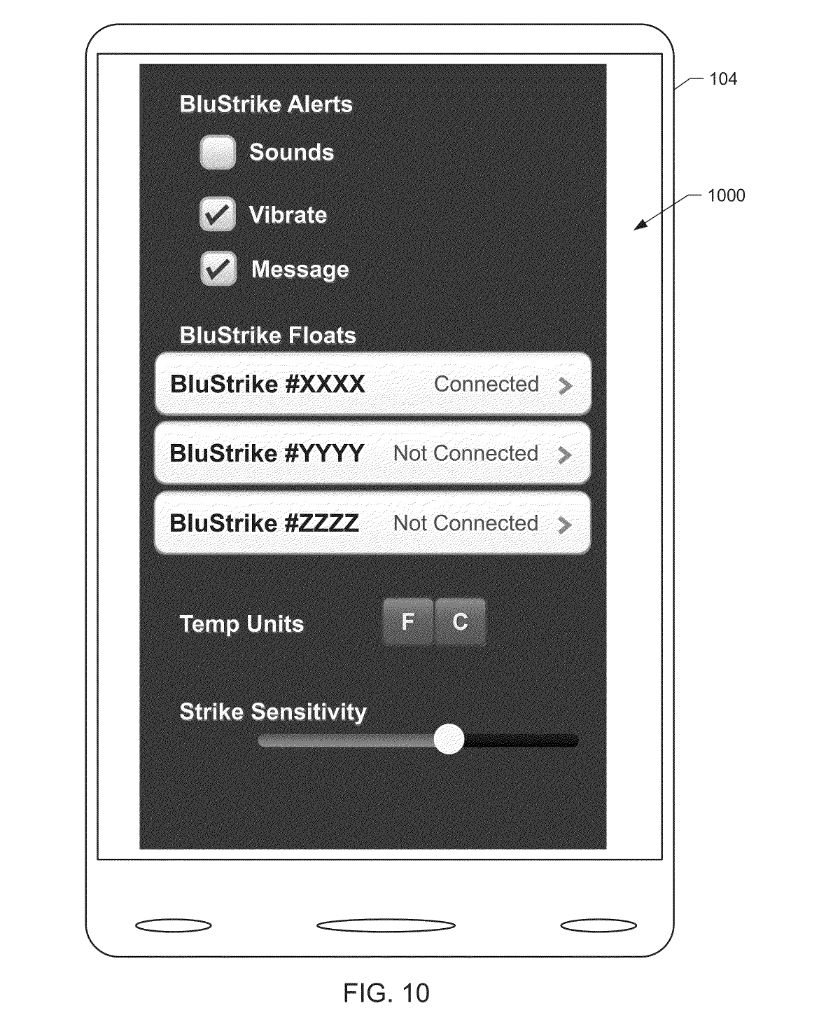

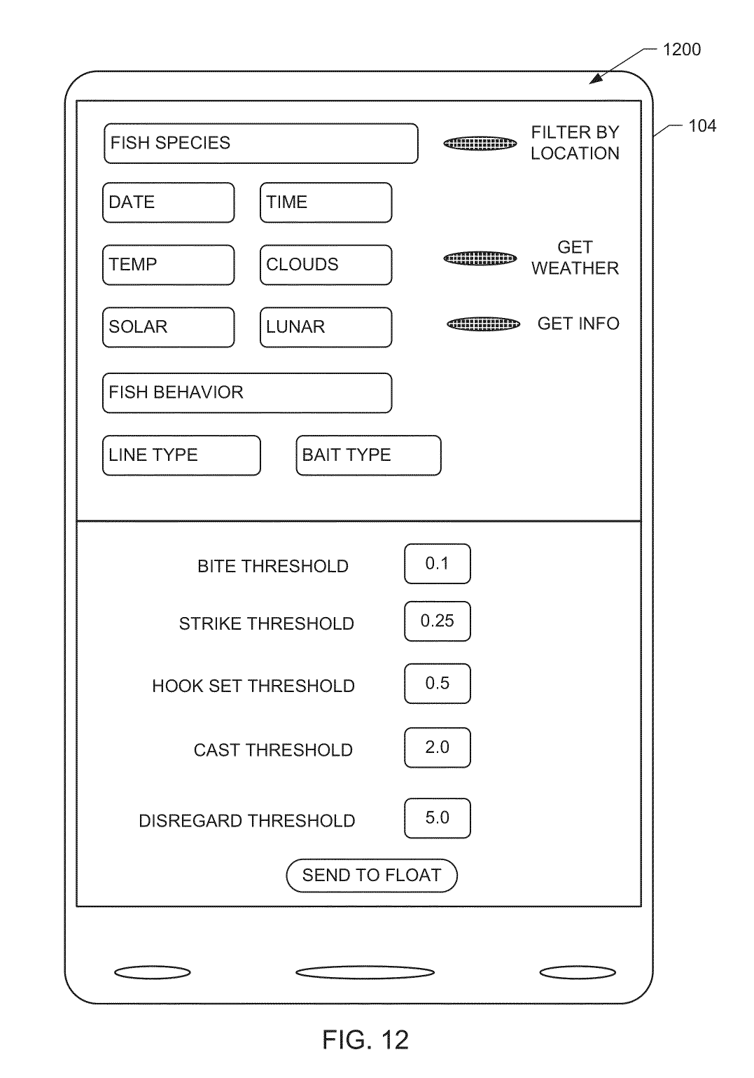

Returning to the illustrated example, the fishing bobber 102 determines whether one or more thresholds (or profiles) 803 have been received from a client device 104 (block 804). For instance, upon powering, the fishing bobber 102 may transmit a threshold request message to the client device 104. Responsive to the message, the client device 104 determines whether a user has specified one or more thresholds and accordingly transmits a response. Alternatively, the client device 104 (after confirming the fishing bobber 102 is active) transmits one or more thresholds after a user has specified the thresholds and/or conditions for determining thresholds. For instance, a user may set a threshold by changing a strike sensitivity property in the user interface 1000 of FIG. 10. In yet an alternative embodiment, the client device 104 may transmit conditions (e.g., fish species, weather, solar/lunar information, estimated fish behavior, time/day) to the fishing bobber 102 (as shown in FIG. 12), which then determines the threshold(s).

As shown in FIG. 8, if a threshold 803 is received from the client device 104, the fishing bobber 102 updates the appropriate threshold stored in the memory 408 accessible by the processor 404 (block 806). The fishing bobber 102 then begins to poll and/or receive data from sensors 406 to detect movement (block 808). For each instance of movement data received from the sensor 406, the fishing bobber 102 converts the movement data (e.g., acceleration) to force data (block 810).

A user may provision the fishing bobber 102 prior to transmit at least one of a substantially continuous steam of force data, periodic intervals of force data, force data above one or more thresholds, and/or indicates of a strike/bite. In these instances, the fishing bobber 102 is configured to determine which transmission setting was selected. It should be noted that these transmission check steps are omitted when the fishing bobber is configured to output data in one manner.

A first check is whether a user has indicated to receive at the client device 104 substantially all force data (block 812). If this is the case, the fishing bobber 102 transmits one or more messages 813 including a value associated with the measured force (block 814). A second check is whether a user has indicated to receive force data above a threshold and/or an indication of a strike/bite (block 816). If this is the case, the fishing bobber 102 transmits one or more messages 813 including values of only forces above the specified threshold and/or indications of strikes/bites/hook set (block 814). The fishing bobber 102 disregards or otherwise deletes forces below the thresholds (block 818). In alternative embodiments, the fishing bobber 102 may compare determined force data over a time period to force profiles.

The example procedure 800 of FIG. 9 continues by the fishing bobber 102 determining a power level of a battery (block 820) and transmitting this power level via message 821 (block 822). The message may also include an alert or warning indicating the power level is below a specified threshold. Alternatively, the client device 104 may provide a low power indication if a power level received from the fishing bobber 102 is below a predetermined level.

The example procedure 800 also measures water quality and/or depth via sensors 416 (including recording video/audio) (block 824). The fishing bobber 102 transmits this water quality data (including video/audio) within one or more messages 825 to the client device 104. The frequency of transmission may be predetermined, based on the power level of a battery, and/or specified by a user. After transmission of the water quality data and force data, the fishing bobber 102 determines if operation is to be stopped (block 828). For instance, the fishing bobber 102 may determine that use has stopped after sensing forces below a threshold for a period of time. Alternatively, a user may deactivate the button 203. If the fishing bobber 102 is deactivated, the procedure 800 ends. However, if the fishing bobber 102 is still active, control returns to step 808 where additional movement is detected.

The example procedure 850 of FIGS. 8 and 9 begin when the client device 104 and/or application 114 is activated (block 852). It should be appreciated that in this example the client device 104 has already been linked to the fishing bobber 102. The client device 104 determines whether a user provides thresholds (e.g., the sensitivity property in FIG. 9) and/or fishing conditions (shown in FIG. 12) (block 854). If a threshold is provided, the client device 104 transmits the one or more thresholds 803 to the fishing bobber 102 (block 856).

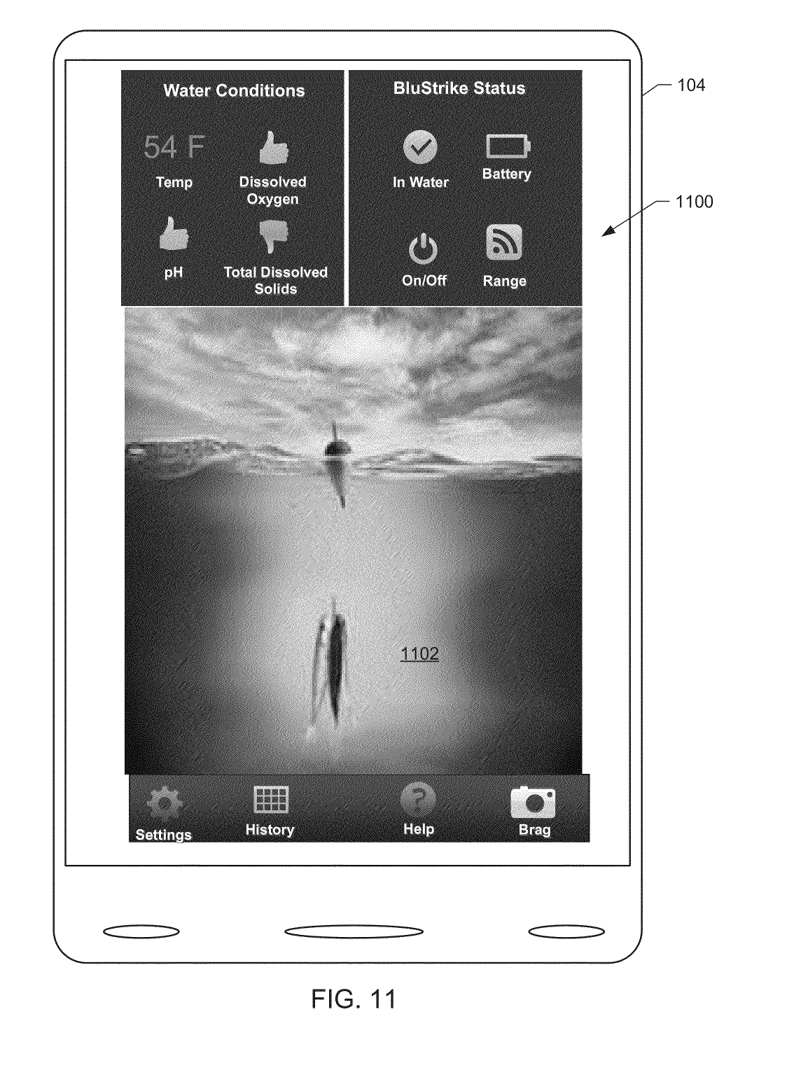

Some time later, the client device 104 receives messages 813 including force data and/or indications of a fish strike/bite/hook set (block 858). These messages may also provide an indication the fishing bobber 102 is active and powered. Responsive to the messages 813, the client device 104 provides an indication of the force and/or fish strike/bite/hook set (block 860). FIG. 9 shows properties of application 114 that are selectable by a user to provide an indication of a fish strike or indication as to when to set a hook. These properties include a sound (e.g., a beep, ringtone, song, etc.), a vibration, and a message. An indication may also include a graphical display of an image, video, and/or animation. For instance, image 1102 of FIG. 11 may be displayed within user interface 1100 responsive to receiving the message 813 including an indication of a fish strike and/or bite. It should be appreciated that the user interface 1000 may enable a user to select an intensity of a property based on the amount force detected by the fishing bobber 102. Moreover, the client device 104 may display a numerical value of the force (or update a graph of force over a time period with the most recently received force value) within the user interface 1100.

The example procedure 850 continues when the client device 104 receives a message 821 indicating of a power level of the fishing bobber (block 862) and one or more messages 825 indicating water quality (block 866). It should be appreciated that the water quality data, power level, and force data may be received at different periodic rates. Thus, two or more instances of force data may be received before water quality data is received at the client device 104. Responsive to receiving the data, the client device 104 displays the power level (block 864) and the water quality (block 868), as shown in the user interface 1100 of FIG. 11. For instance, the water quality is displayed as graphical indicators. However, in other examples the values of water quality (e.g., pH value) may be displayed.

After displaying the power level and water quality, the client device 104 determines if the bobber has been deactivated (block 870). If the fishing bobber is still active, control returns to step 858 where force data and/or an indication of a fish strike/bite/hook set is received. However, if the bobber 102 has been deactivated, the procedure 850 ends.

### Client Device Application

As discussed, the client device 104 operates an application 114 that provides unique functionality based on force data applied by fish. The application 114 may be locally installed on the client device 104. Alternatively, the application 114 may be hosted by the service provider 106 and be accessible via a web browser or interface on the client device 104.

### (i) Configuration

The client device 104 of FIGS. 1, 8, and 10 enables a user to configure the application 114 and/or provision one or more fishing bobbers 102. FIG. 10 shows an example user interface 1000 that includes configurable properties for fish strike alerts, data display, and detection sensitivity. The user interface 1000 also includes a list of fishing bobbers 102 (identified by identifier) that are linked or otherwise associated with the client device 104. A user may select one of the listed fishing bobbers 102 to disconnect, initiate a connection (e.g., instituting a Bluetooth® link), activate, deactivate, view the bobber's location on a map, and/or view head/distance to the bobber. The client device 104 displays an additional fishing bobber 102 within the list responsive to receiving a connection request.

The user interface 1000 may also enable a user to select the type and/or frequency of data received from the fishing bobber 102. As discussed above, a user may select to receive substantially all force data, force data above a threshold (e.g., sensitivity), and/or indications of a fish strike/bite/hook set. Alternatively, the type and/or frequency of data may be determined by a developer and is unable to be changed by a user.

The user interface 1200 of FIG. 12 enables a user to specify one or more thresholds. For instance, the user interface 1200 enables a user to specify fish species (which may be filtered based on the user's location or body of water), date, time, temperature, cloud cover, solar/lunar information, estimated fish behavior, line type, and bait type. In some instances, the user interface 1200 enables a user (and/or the application 114) to access and acquire the information for a web service (e.g., a government database of indigenous fish species, weather web site, etc.).

The application 114 on the client device 104 uses the input information to determine force thresholds, which may be communicated to a corresponding fishing bobber 102. Alternatively, the application 114 may use the thresholds for determining when a user is to be notified and/or the type of notification provided to a user. Further, the user interface 1200 may enable a user to modify and/or customize the thresholds based on their own fishing experience and/or preferences. For example, a user could select to remove a bite threshold and increase the value of the strike threshold.

In some instances, the application 114 may be configured to generate a force profile based on the information specified in the user interface 1200 of FIG. 12. The application 114 could generate a force profile for each of a bite, a strike, a hook set, and/or a cast. In these instances, the user interface 1200 may display a graph of the generated force profile (force in relation to time) and enable a user to modify the graph including a rate at which force increases/decreases.

### (ii) Data Display

The example client device 104 is configured to provide an indication of a fish bite/strike/hook set in conjunction with water quality data and/or bobber data. For example, FIG. 11 shows user interface 1100 that includes a graphical indication of a fish strike 1102, water quality data, and bobber data. It should be appreciated that the manner in which the data is displayed and/or presented to the user may vary based on configuration settings and/or design choices. For instance, the water quality data could include numerical values of water quality parameters. Moreover, the water quality may include an indication as to whether it is a good time to catch a fish specifies identified by a user. For example, the application 114 may reference the water quality parameters to a fish species identified by a user and determine whether those conditions are favorable for catching that fish species. Thus, if, for example, dissolved oxygen and water temperature is low for trout, the application 114 may provide an indication that conditions are not favorable for catching trout.

Regarding bobber status, a user may select the range icon in the user interface 1100 to view information regarding the bobber 102 including a distance/heading relative to the client device 104. The application 114 may determine the distance and/or heading based on signal strength from the bobber 102, GPS coordinates transmitted by the bobber, etc. This feature enables a user to track locations of multiple bobbers 102 and/or find misplaced/lost bobbers 102.

In addition to water quality data and bobber status data, the user interface 1100 may also be configured to provide video/images/audio/sonar/thermal images. For example, the user interface 1100 may include a window that shows real-time video/images and/or audio recorded by a camera within the bobber 102. The window could also include thermal images and/or sonar images based on corresponding sensors 416 within the bobber 102. It should be appreciated that the application 114 includes functionality to process/filter/render such data as it is received from the bobber 102 so as to present the data in a displayable format.

As shown in FIG. 11, the indication of a fish strike 1102 includes a graphical display 1102. However, other indications of fish strikes can include audio, video, vibrations, illumination of an LED, etc. As shown in FIG. 10, the user interface 1000 enables a user to select the type/intensity of the notification. Further, as shown in FIG. 12, the user interface 1200 enables a user to select when indications are provided. In some instances, the application 114 enables a user to specify a ring tone, song, animation, etc. that is provided for each type of fish strike, bite, hook set, case, etc.

Further, the user interface 1100 may display force values in conjunction with indications of fish strikes/bites. For instance, the user interface 1100 may display a numerical value of force received from the bobber 102 and/or a graph of the force over time including the most recent force. The application 114 determines if the force corresponds to a fish strike/bite and causes the appropriate indication to be provided. The application 114 may also determine when a hook should be set and causes the appropriate indication to be provided to the user. Alternatively, the fishing bobber 102 may make these determinations and the application 114 is configured to provide the indications as received. In one specific example, the user interface 1100 may cause a chime to sound upon detecting forces corresponding to a fish bite, a ring tone of “OH YEAH”, when there is a fish strike, and cause the client device 104 to vibrate when it is time to set the hook.

The example user interface 1200 may also be configured to provide an estimate of the fish species and/or size based on the force data. For instance, the application 114 may match a force profile of a fish bite/strike to bite profiles for different species of fish to determine which species has been caught. The application 114 may also estimate a fish size/weight based on the force data (e.g., more force corresponding to a relatively larger fish).

In addition to providing indications of fish strikes/bites, the user interface 1200 (and/or a different user interface) may display data associated with casting and/or reeling. For example, upon detecting a cast, the user interface 1200 may display a distance of the cast and/or force associated with the cast. Similarly, the user interface 1200 may display a distance line has been reeled and/or detected line force during reeling. Such a configuration may enable users to have friendly competitions to see who can cast the farthest.

### (iii) Data Correlation

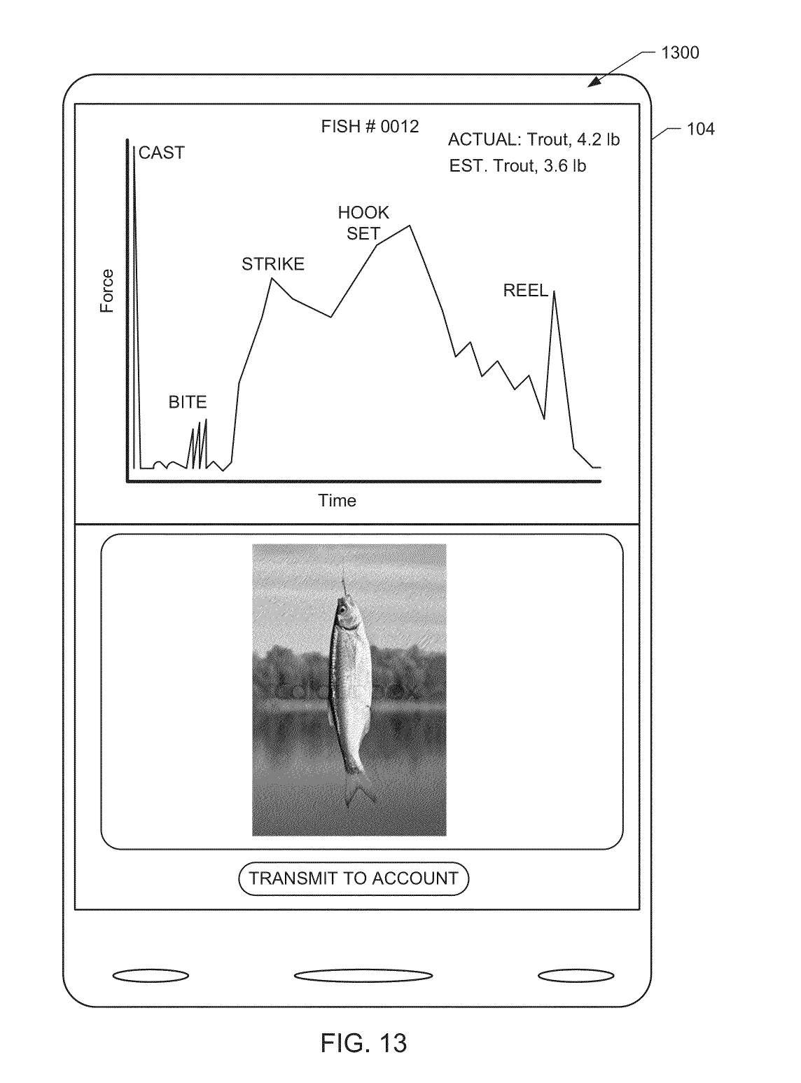

FIG. 13 shows a user interface 1300 that includes a graph of force data received from a bobber 102 over a time period during which a user caught a fish. In this illustrated example, the application 114 is configured to record force data and graph this force data for different events. For instance, upon catching and reeling in a fish, a user can specify via the interface 1200 and/or 1300 that a fish was caught. Upon receiving a specification of the event, the application 114 accesses the previous force data (from, for example, a cast) for graphing and correlation. The interface 1200 and/or 1300 may include functionality that prompts the user for the fish species, weight, bait type, etc. The application 114 may also use the information provided by the user within interface 1200. The interface may further cause a camera and/or video function on the client device 104 to be opened to enable the user to easily record the event. The user interface may also prompt the user for notes regarding the catch.

As shown in the user interface 1300 of FIG. 13, the example application 114 correlates the data from the catch and presents this correlated data in a graphical format. A graph shows the recorded force during the catch including labels for the cast, bite, strike, hook set, and reel. The graph also includes an estimate regarding the fish species and weight provided by the application 114 after the fish was initially hooked and the actual species and weight as provided by the user (or determined by the application 114 upon analyzing images of the caught fish). In other embodiments, the user interface 1300 may correlate other data, such as water quality, weather, solar/lunar, geographic location, etc., with the force data and/or catch data. This correlated data may be displayed as one or more icons within a graph or displayed in conjunction with the graph (e.g., display weather conditions under the fish type).

The user interface 1300 also includes an image and/or video of the catch recorded by the client device 104. A user may select a function on the user interface 1300 to store the catch data to memory, transmit the data to the client processor 110, the service provider 106, and/or a third-party service provider 108 (e.g., post to a Facebook® wall, pin to Pinterest®, send to a government creal survey group, etc.). The user interface 1300 may also enable a user to communicate with other users of the example bobber 102 of FIGS. 1 to 4.

### (iv) Feedback

The example application 114 operating on the client device 104 may also provide fishing feedback and/or strategies to a user. For instance, the application 114 may display information regarding typical fish in an area specified by a user, information regarding how to catch certain species of fish, information regarding how fish strike, etc. The application 114 may monitor the force data to determine if a user needs correction regarding a fishing technique. For instance, upon determining that a user is targeting walleye, the application 114 analyzes force data associated with bites/strikes to determine if the user is setting the hook at the appropriate time. The application 114 may display one or more tips (such as indications to provide more slack after sensing initial bites) to help the user correct fishing techniques for the desired fish.

The example application 114 may also enable a user to access a chat or feedback feature to interface with other users and/or help staff. For example, the user interface 1100 may includes a feature that enables a user to submit questions to help staff associated with the service provider 106. Additionally or alternatively, a user interface may display a list of other users within a certain distance (or fishing on the same body of water) of the user such that the user can broadcast a question to this group of users (e.g., “anyone catch trout this morning, and where?”).

### Fish Strike Service Provider

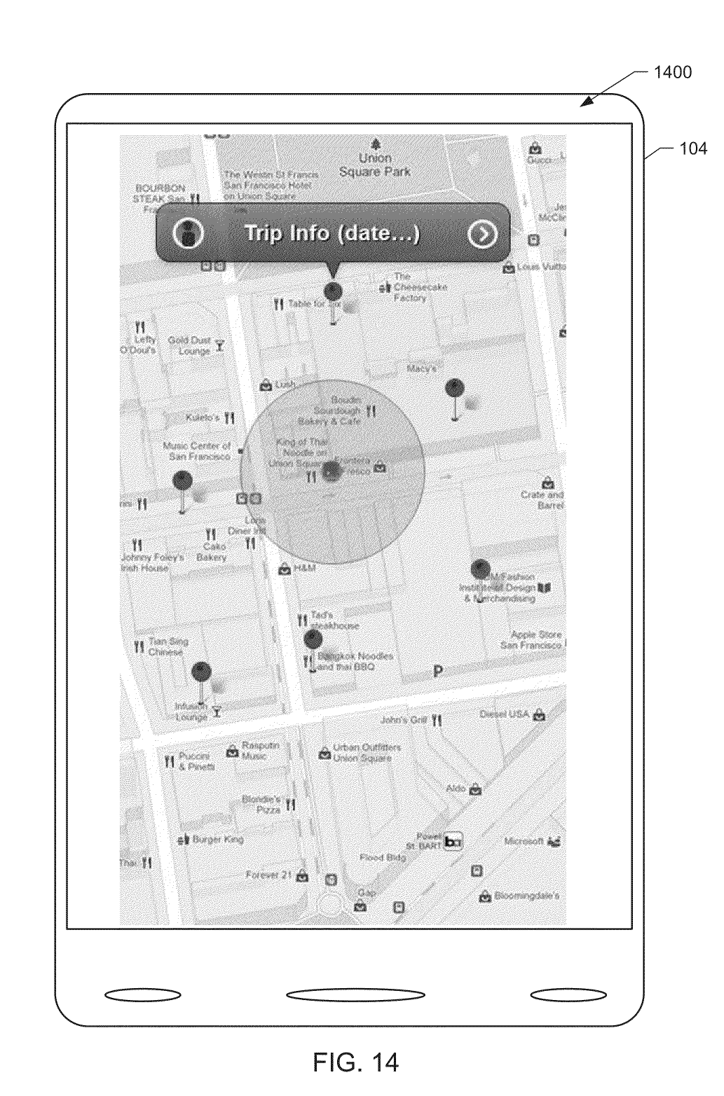

As discussed above, the example fish strike service provider 106 aggregates force data and/or fish catch data from a plurality of users. The service provider 106 may provide different contexts of this aggregated data for different types of users. For example, FIG. 14 shows a user interface 1400 of locations on a map as to where different users have caught fish. A user may select any of the icons to view more information associated with the catch including fish species, weight, time/day, bait used, etc. The application 114 on each client device 104 may transmit catch data (including geographic location as determined by GPS/cellular functionality or provided by the user). The service provider 106 stores the received data to a database and hosts a web service that maps the stored data. The service provider 106 may filter the data such that data within a certain time period (e.g., the past week) is displayed. In some embodiments, the service provider 106 may enable a user to filter which data is displayed by the user's client device 104 (e.g., filter based on time period, fish species, bait used, etc.). In this manner, the service provider 106 provides crowd-sourced fishing.

The example service provider 106 may also host messaging and/or other communication mediums to enable users to exchange information. For example, the service provider 106 may transmit to client devices 104 a list of other users within a certain proximity (assuming a user opts into such a service). The service provider 106 may also enable users to use this list to message and/or communicate with other users. The service provider 106 may also store a data structure of user information referenced to a bobber identifier. Such information enables lost bobbers to be returned to rightful owners.

In additional to providing user-context information, the service provider may host (or provide a framework to enable) competitions and/or promotions. For example, a sporting goods store may use the service provider 106 to transmit a bait promotion to users fishing within a specified distance from the store. In another example, a virtual fishing competition may use catch data to verify fishing results of competitors.

The example service provider 106 may also provide information for a government-context. For example, the service provider 106 may provide access to one or more databases of catch data to enable governments to conduct virtual creal surveys or support unattended line laws. Alternatively, a government entity may register with the service provider 106 such that the service provider 106 transmits only catch data of interest by the government entity (e.g., catch data for certain rivers, lakes, fish species, etc.). A government wildlife department may use such data to determine when to restock a particular species of fish.

The example service provider 106 may also provide aggregated water quality data to governments and/or users. It should be appreciated that the service provider 106 is in a unique position to collect water quality from frequently fished bodies of water to provide a profile of water quality over different parts of the body of water for different times/days. The service provider 106 may provide this information to users in the context of appropriate conditions for fishing. In the same manner, the service provider 106 may provide this information to government departments in the context of water quality data that may be modeled over the entire body of water during different time periods. A government department could use this information to identify sources of pollution and/or determine how water quality conditions change based on factors such as weather, time of year, etc.

### CONCLUSION

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus comprising:
a housing that includes a first portion and a second portion, the first portion being connectable to the second portion to create a watertight seal, the housing enclosing:
a sensor configured to measure a force applied to the housing;
a processor communicatively coupled to the sensor configured to (i) determine the force based on an output from the sensor (ii) and determine if the force corresponds to a fish strike;
a transceiver communicatively coupled to the processor configured to wirelessly transmit an indication of the fish strike; and
a power source configured to provide power to the sensor, the processor, and the transceiver.

2. The apparatus of claim 1, wherein the processor is configured to send an indication of a fish strike responsive to determining that a change in the force indicates the fish strike.

3. The apparatus of claim 1, wherein the processor is configured to cause the transceiver to wirelessly transmit the indication of the force.

4. The apparatus of claim 1, wherein the processor is configured to determine if outputs from the sensor correspond to a casting of the housing into water and to disregard such outputs.

5. The apparatus of claim 1, wherein the sensor includes an accelerometer configured to measure downward acceleration of the housing while the housing is floating in water.

6. The apparatus of claim 1, further comprising a second sensor integrated into the housing and communicatively coupled to the processor, the second sensor configured to measure at least one of water temperature, dissolved oxygen, salinity, turbidity, total dissolved solids, and pH, wherein the processor and the transceiver are configured to wirelessly process and transmit the data measured by the second sensor.

7. The apparatus of claim 1, wherein the power source includes a transducer that converts force into power.

8. A system comprising:
a fishing bobber enclosing:
a sensor configured to measure a force applied to the fishing bobber; and
a bobber processor communicatively coupled to the sensor configured to (i) determine the force based on an output from the sensor, (ii) determine if the force corresponds to a fish strike, and (iii) wirelessly transmit an indication of the fish strike; and
a client device comprising a wireless receiver and at least one client processor, the client processor configured to operate with the wireless receiver and at least one display device to:
receive the indication of the fish strike from the bobber processor; and
cause a display of the indication of the fish strike.

9. The system of claim 8, wherein the bobber processor is configured to send the indication of the fish strike responsive to determining that the force exceeds a predefined threshold, and the client device is configured to transmit the predefined threshold to the bobber processor.

10. The system of claim 9, wherein the predefined threshold is based on at least one of a user-specified value, a specified target fish species, a time of day, and an expected mood of fish.

11. The system of claim 8, wherein the bobber processor is configured to wirelessly transmit an indication of the force and the client device is configured to graphically indicate the force.

12. The system of claim 11, wherein client device is configured to vibrate at an intensity proportional to the force.

13. The system of claim 11, wherein client device is configured to provide an audio indication at an intensity proportional to the force.

14. The system of claim 8, wherein the client device is configured to display a graphical indication of a cast responsive to determining the force corresponds to a cast of the fishing bobber.

15. The system of claim 8, further comprising:
a second fishing bobber enclosing:
a second sensor configured to measure a force applied to the second fishing bobber; and
a second bobber processor communicatively coupled to the second sensor configured to (i) determine the force based on an output from the second sensor, (ii) determine if the force corresponds to the fish strike, and (iii) wirelessly transmit a second indication of the fish strike.

16. The system of claim 15, wherein the indication from the bobber processor includes a first identifier, the second indication from the second bobber processor includes a second identifier, and the client device is configured to indicate which of the fishing bobber and the second fishing bobber is associated with the fish strike.

17. The system of claim 8, wherein the client device is communicatively paired with the bobber processor.

18. The system of claim 8, wherein the client device is communicatively coupled to a network and is configured to transmit the indication of the fish strike and a geographical location of the fish strike to a specified website.

19. A method of detecting a fish strike comprising:
detecting via a sensor a force applied to a fishing bobber;
determining via a processor if the detected force exceeds a predetermined threshold;
transmitting wirelessly via the processor an indication of the fish strike responsive to the force exceeding the predetermined threshold;
receiving the indication of the fish strike in a client device; and
indicating via the client device the detected fish strike.

20. The method of claim 19, further comprising storing force detected over a time period to a memory.

21. The method of claim 20, further comprising transmitting the stored force over the time period to the client device responsive to receiving a request from the client device.

22. The method of claim 19, further comprising:
detecting via a second sensor at least one of water temperature, dissolved oxygen, salinity, turbidity, total dissolved solids, and pH;
transmitting wirelessly from the processor data measured by the second sensor; and
displaying via the client device the data measured by the second sensor.

23. The method of claim 22, further comprising:
correlating the force measured over the time period with the data measured by the second sensor; and
graphically displaying the correlation via the client device.

24. The method of claim 19, further comprising starting a camera function on the client device responsive to receiving the indication of the fish strike.
